(19) United States
(12) Patent Application Publication
(10) Pub. No.: US 2007/0166143 A1
(43) Pub. Date: Jul. 19, 2007

(54) Quick coupler lock system

(76) Inventors: Michael D. Hart, Lynnwood, WA (US); Walter J. Pisco, Mercer Island, WA (US)

Correspondence Address: Chernoff Vilhauer McClung & Stenzel, LLP, 1600 ODS Tower, 601 SW Second Avenue, Portland, OR, 97204, US

(21) Appl. No.: 11/331,582

(22) Filed: Jan. 13, 2006

(51) Int. Cl. B66C 23/00

(52) U.S. Cl. 414/723

(57) ABSTRACT

A quick coupler lock, for use as a safety to engage an attachment, such as a bucket or scoop, to a heavy equipment armature, as found in backhoes and excavators. The coupler lock prevents the unwanted release of auxiliary attachments. The coupler lock includes a coupler frame with a pin grabber, and a coupler hook rotated to engage a pin. The rotation of the coupler hook is accomplished by the extension or retraction of a coupler actuator, preferably a hydraulic cylinder held within a spring. The coupler actuator hingably connects to a pivoting lock lever. The action of the coupler actuator rotates the lock lever about the lever pin. A lock bar hingably attaches to the coupler hook and rotates with the coupler hook. The lock lever includes an arm that contacts the lock bar, to prevent movement of the coupler hook and prevent the unwanted release of the pin.

### TECHNICAL FIELD

The invention relates to a mechanical system for safely engaging an attachment such as a bucket or scoop, to a hydraulic armature, as employed with conventional heavy equipment, such as backhoes and excavators.

### BACKGROUND OF THE INVENTION

Heavy equipment manufacturers typically employ hydraulic actuators to move and articulate arms, booms, buckets and auxiliary tools. These auxiliary tools can include hydraulically actuated attachments, such as scoops, fingers and grapples. A savings in the cost of purchasing and operating heavy equipment, such as backhoes and excavators, can be realized if attachments are removable and interchangeable. This enables a particular piece of heavy equipment to perform more than one function, increasing the usefulness of the equipment and possibly eliminating the need to purchase additional equipment. However, the ability to quickly switch from one attachment to another, creates the need for a quick coupling system that minimizes any possibility of an inadvertent release of the auxiliary attachment.

An example of such safety lock systems for auxiliary attachments to heavy equipment is found in U.S. Pat. No. 6,379,075 to Shamblin et al., which shows a quick coupler with hydraulic and mechanical locking mechanisms to insure the inadvertent release of an attached bucket.

However, it is observed that this prior safety lock is activated only upon a loss of hydraulic pressure. Therefore, a safety interlock for attachments to heavy equipment is needed that is always engaged when the attachment is coupled, and is easily disengaged, when de-coupling of the attachment is necessary.

The present invention addresses these shortcomings of prior safety interlocks for auxiliary attachments to heavy equipment and will be better understood by reference to the following detailed description taken in conjunction with the accompanying drawings.

### BRIEF DESCRIPTION OF DRAWINGS

FIG. 1 is a side view of a coupler lock, according to an embodiment of the invention;

FIG. 2 is a side view of a coupler lock, according to an embodiment of the invention;

FIG. 3 is side view of a coupler lock, according to an embodiment of the invention;

FIG. 4 is side view of a coupler lock, according to an embodiment of the invention;

FIG. 5 is an exploded perspective view of a coupler lock, according to an embodiment of the invention;

FIG. 6 is a top view of a coupler lock, according to an embodiment of the invention;

FIG. 7 is a partially sectioned perspective view of a coupler lock, according to an embodiment of the invention;

FIG. 8 is a partially sectioned perspective view of a coupler lock, according to an embodiment of the invention;

FIG. 9 is a partially sectioned perspective view of a coupler lock, according to an embodiment of the invention;

FIG. 10 is a perspective view of a coupler lock mounted to a boom member, according to an embodiment of the invention;

FIG. 11 is a perspective view of a coupler lock mounted to a boom member, according to an embodiment of the invention;

FIG. 12 is a perspective view of a coupler lock mounted to a boom member, according to an embodiment of the invention; and

FIG. 13 is a perspective view of a coupler lock mounted to a boom member, according to an embodiment of the invention.

### DETAILED DESCRIPTION OF SPECIFIC EMBODIMENTS

The present invention relates to a coupler lock system, useful as a safety for preventing the unwanted release of an auxiliary attachment from a “quick coupler,” also referred to herein as a coupler assembly. As discussed above, quick couplers are widely utilized in the easy connection and release of auxiliary attachments, to and from heavy equipment booms, typically while at a work site, or in the field. These heavy equipment booms are typically actuated by hydraulic mechanisms, and controlled by an operator. With a quick coupler, a heavy equipment boom may switch easily from one attachment to another, as the job requires. For example, a bucket may need to be switched out with a grapple, or a broken bucket may need to be changed-out for repair.

The Quick Coupler Lock System

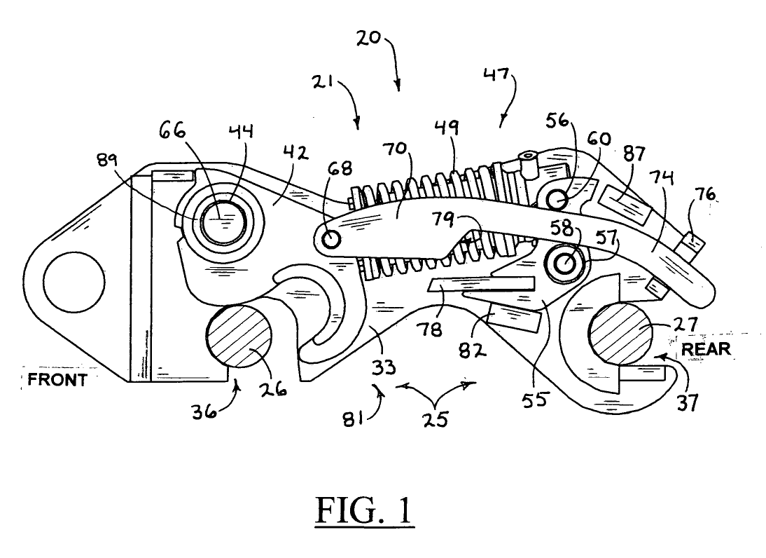

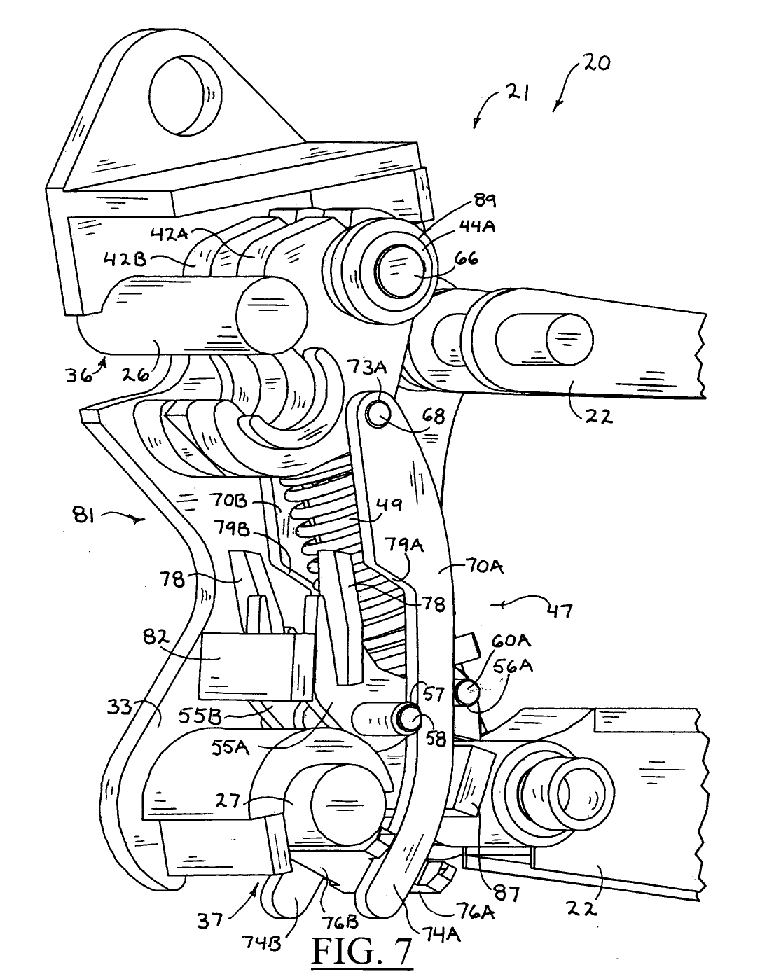

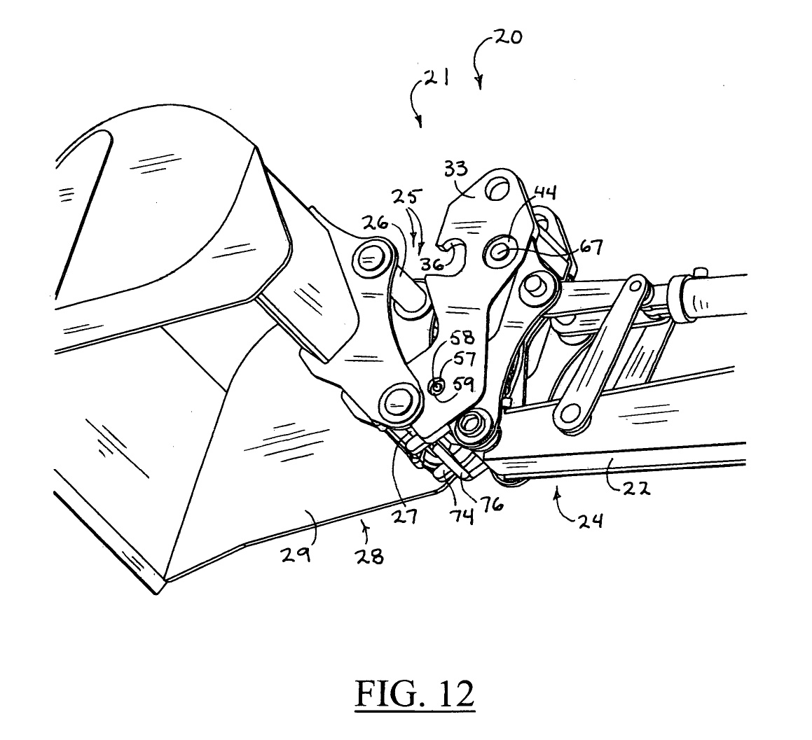

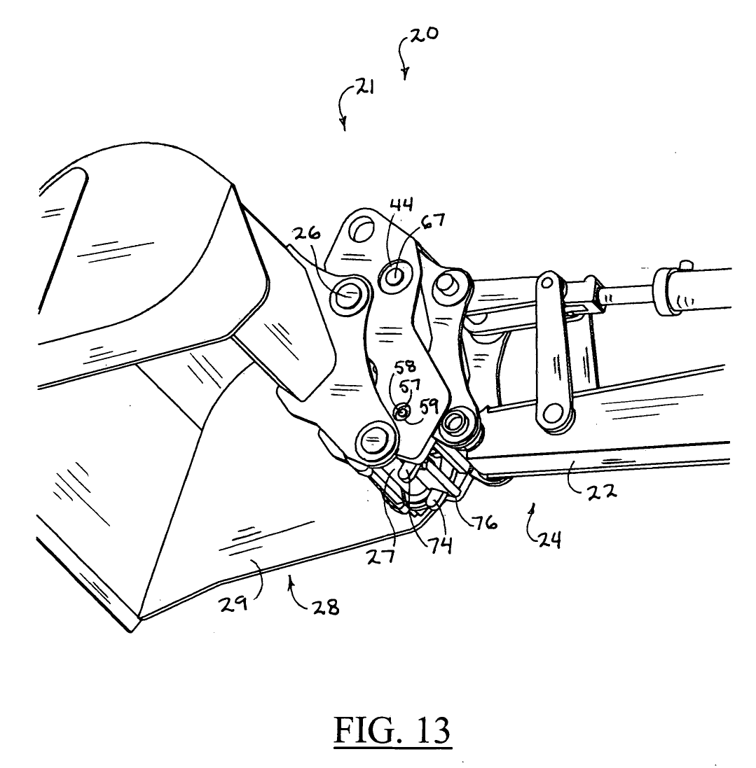

FIGS. 1 through 13 show features of a preferred embodiment of a coupler assembly 21, which includes the coupler lock system 20 of the present invention. The coupler assembly is mountable to a boom arm 22, which typically extends from a heavy equipment apparatus 24. Especially in backhoe applications, the boom arm may be referred to as a “dipper arm.” A primary purpose of the coupler assembly is coupling to or “engaging” with an attachment 28, such as a bucket 29 as shown in FIG. 13. As discussed above, the attachment may be any of a wide variety of tools adapted for mounting to the boom arm, with use of the coupler assembly. These tools and similar, typically hydraulically actuated attachments include scoops, fingers and grapples, often employed with conventional backhoes and excavators.

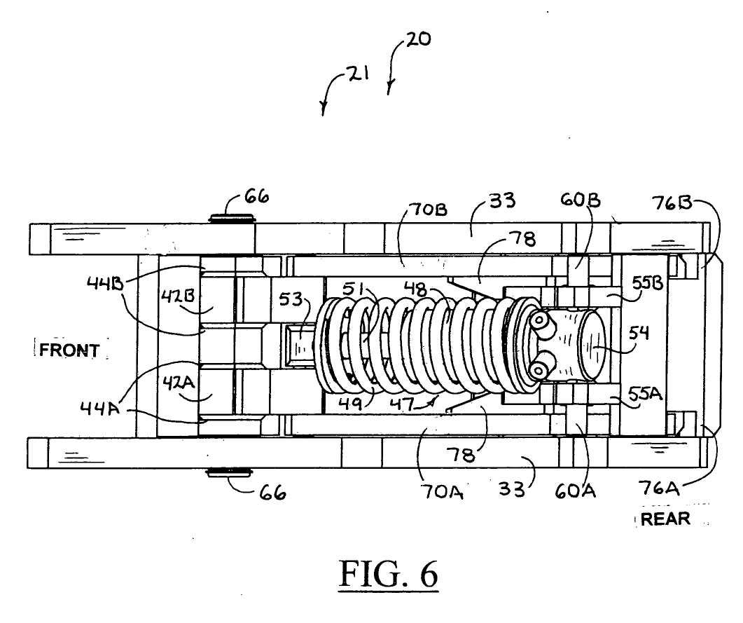

Many conventional attachments 28 to boom arms 22 employ a set of pins 25, which can be permanently mounted at the end of the boom arm, or detachable from the boom arm, in the alternative. The configuration of the set of pins has become standardized for many heavy equipment manufactures, which encourages the interchange of boom arm attachments, as manufactured by most makers of heavy equipment apparatus 24. Specifically, the set of pins typically includes a front pin 26, parallel to a rear pin 27. The “front” and “rear” of the coupler assembly 21 are, for the purposes of this disclosure, designated as indicated in FIGS. 1 and 6. The front and rear pins, conforming to manufacturers' standards, are typically cylindrical steel bars or high strength tubes, both pins of approximately the same diameter and length, the pins are parallel to and separated from each other by a short distance. Within reasonable ranges of variation, as understood by those persons skilled in the field of auxiliary attachments for use with quick couplers, the lengths, diameters and separations of the pins are not critical to the present invention. Pin lengths of ten inches to two feet, pin separations distances of one to three feet and pin diameters of two to six inches are considered typical, but are all broadly approximate and should not be considered as limiting the present invention. Additionally, the total number of pins is not considered a vitally element for the coupler lock system 20 of the present invention. Specifically, although the set of two pins are preferred, a single pin, described herein as the front pin, or any multiple of pins could be employed with the safety coupling features of the coupler assembly herein described.

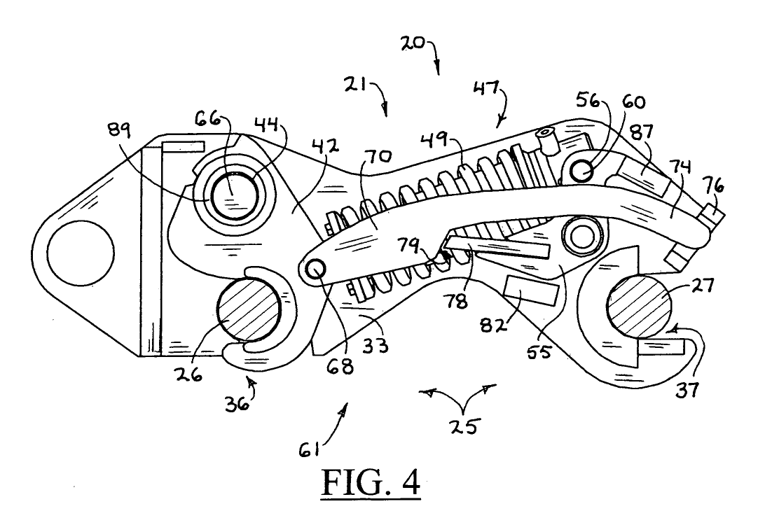

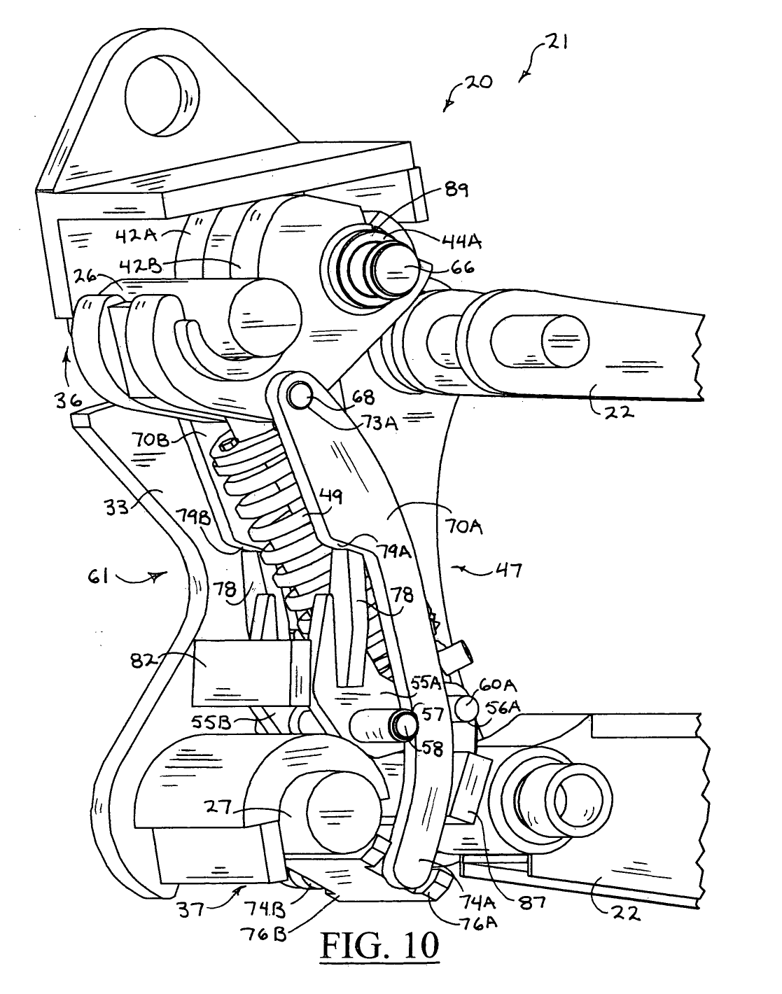

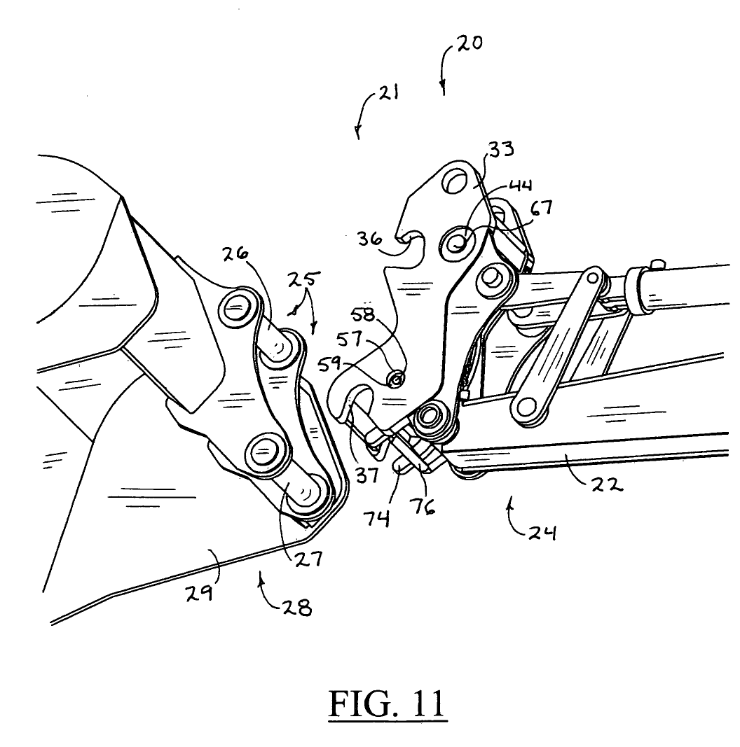

As detailed in FIG. 1, the coupler assembly 21 includes a coupler frame 33, with a front pin grabber 36 and a rear pin grabber 37. The front pin grabber receives and holds the front pin 26, and the rear pin grabber receives and holds the rear pin 27, of the set of pins 25. In a preferred coupling operation of the present invention, the rear pin is received by the first rear pin grabber, as shown in FIG. 10, followed by the rotation of the entire coupler assembly by the boom arm 22, as shown in FIG. 11. The front pin is then received by the front pin grabber, as shown in FIG. 13. A coupler hook 42 is then rotated to engage the front pin, as shown in FIG. 4. The coupler hook pivotably attaches to the coupler frame at a coupler hook pivot 44.

Rotating the coupler hook 42 about the coupler hook pivot 44 selectively engages or releases the front pin 26. The rotation of the coupler hook is accomplished by the extension or retraction of a coupler actuator 47. The coupler actuator is preferably a hydraulic cylinder 48 held within a holding spring 49, as shown in FIGS. 1 through 4. The hydraulic cylinder is a common actuating device that uses a substantially incompressible fluid under pressure, to force the extension of a piston 51 from a cylinder body 52. Other actuation devices are considered for use with alternative embodiments of the present invention.

The coupler actuator 47 includes a hook end 53, opposite a lock lever end 54. The lock lever end of the coupler actuator hingably connects to a lock lever 55 at a lever actuator pivot 56. The lock lever rotates about a lock lever pivot 57. As shown in FIGS. 1 through 4, the lock lever pivot is preferably positioned on the coupler frame 33, and includes a lever pin 58, which is centered within the lock lever pivot. Most preferably, the lever pin seats within a lever pin frame bearing 59 mounted within the coupler frame. The extending or retracting action of the coupler actuator pivotably cranks the lock lever about the lever pin, at the lock lever pivot.

A lever actuator pin 60 is preferably received within the lever actuator pivot 56. The lever actuator pin extends from the lock lever end 54 of the coupler actuator 47, as shown in FIGS. 1 through 4. The lock lever 55 hingably pivots on the lever actuator pin of the lever actuator pivot, upon movement of the coupler actuator.

As most preferred for the present invention, the piston 51 of the coupler actuator 47 is normally extended, unless forced to retract, hydraulicly. With the piston extended, the coupler hook 42 is in an engaged position 61, which holds the front pin 26 within the front pin grabber 36. As discussed above, the coupler hook rotates about the coupler frame 33 at the coupler hook pivot 44. A hook pin 66 is preferably included within the coupler hook pivot. The hook pin seats within a hook pin frame bearing 67 in the coupler frame. Actuation of the coupler actuator pivotably cranks the coupler hook about the hook pin, at the coupler hook pivot.

Preferably, the holding spring 49, of the coupler actuator 47 coaxially receives the hydraulic cylinder 48 and piston 51. The compressive resistance of the holding spring aids to prevent the piston from inadvertently retracting into the hydraulic cylinder from the engaged position 61, without an overriding hydraulic actuation to retract the piston. The holding spring is preferably a conventional helical coil formed of steel, as is typical for use with high compression mechanical forces.

The hook end 53 of the coupler actuator 47 hingably connects to the coupler hook 42 at a hook actuator pivot 63. Actuation of the coupler actuator pivotably cranks the coupler hook about the coupler hook pivot 44. The coupler hook pivot can include a bar pin 68 within the pivot as shown in FIGS. 1 through 4.

A lock bar 70 is also hingably attached to the coupler hook 42, preferably at the hook actuator pivot 63. The lock bar includes a bar pivot 73, which is most preferably co-located with the hook actuator pivot, in a preferred embodiment of the coupler assembly 21. The hook actuator pivot and the bar pivot preferably share the bar pin 68, to rotate about a common axis. However, as an alternative, the bar pivot and the hook actuator pivot need not be located at the same position on the coupler hook. The lock bar rotates with the coupler hook as the coupler actuator 47 cranks the coupler hook about the coupler hook pivot 44.

Opposite to the bar pivot 73, the lock bar 70 includes a lock bar arm 74, which extends through a lock bar collar 76, as shown in FIG. 4. As the coupler hook 42 rotates about the coupler hook pivot 44 to release the front pin 26, the lock bar extends through the lock bar collar. This preferred configuration serves to maintain the lock bar in an approximately linear action, for secure engagement by the lock lever 55. The term “approximately” is used in this description as encompassing any generalized measurements and alternative locations or interrelations of elements, such as pivots, bearings and moving parts, which can still function similarly to the elements described herein, with the advantages made possible by the structure and method of the present invention.

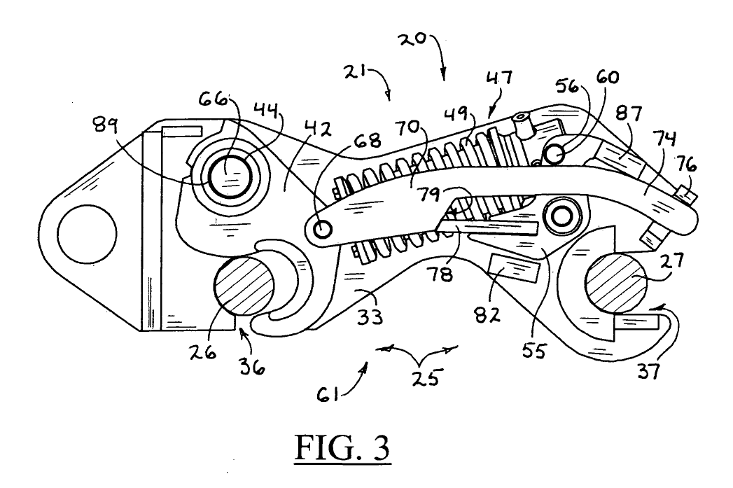

The lock lever includes a lock lever arm 78, opposite the lever actuator pivot 56, about the lock lever pivot 57, as shown in FIG. 3. The lock lever arm contacts a lock bar engage surface 79, to prevent movement of the coupler hook out of the engaged position 61.

The lock bar engage surface 79 is located on the lock bar 70, as shown on FIGS. 1 through 4. Preferably, the lock bar engage surface is preferably located proximate to a midpoint of the lock bar, between the bar pivot 73 and the portion of the lock bar arm 74 received by the lock bar collar 76. As most preferred, the lock bar arm begins and extends from the lock bar engage surface on the lock bar. In a preferred embodiment of the coupler assembly 21, the slope or shape of the lock bar surface substantially matches the corresponding slope or surface of the lock lever arm 78, at the tip portion of the lock lever arm where it is received by the lock bar engage surface.

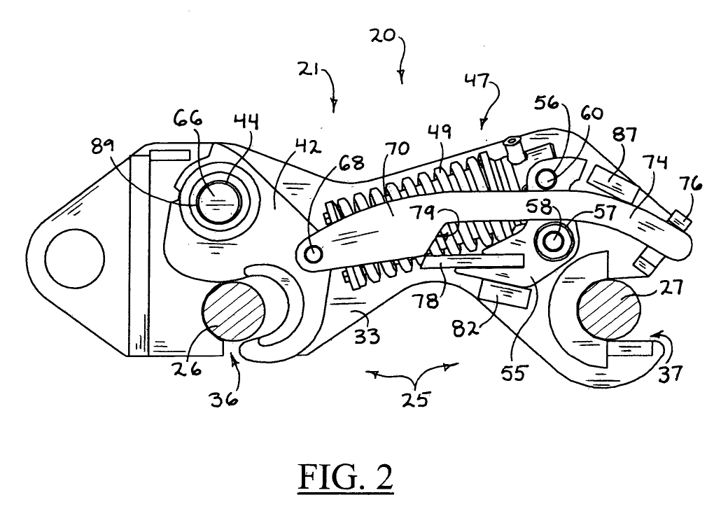

The lock bar 70, the lock lever 55, act together in the coupler lock system 20 to prevent the coupler assembly 21 from releasing the set of pins 25. As discussed above, this set of pins may be part of any attachment 28, such as the bucket 29. The set of pins remain engaged by the coupler assembly, unless hydraulic pressure is directed to the hydraulic cylinder 48 of the coupler actuator 47, forcing the piston 51 to retract against the resistance of the holding spring 49 and release the front pin 26, by rotating the lock lever 55 off and away from the lock bar engage surface 79, as shown in FIG. 2.

Method of Operation

The operational method of a preferred embodiment of the coupler lock system 20 is shown in FIGS. 1 through 4, and discussed as follows: FIG. 1 shows the coupler assembly 21 with the piston 51 of the coupler actuator 47 fully retracted within its cylinder body 52, to a released position 81. In this released position, the lock lever arm 78 of the lock lever 55 abuts against a release stop block 82. With the release stop block preventing further rotation of the lock lever about the lock lever pivot 57, the lever actuator pivot 56 is held in place. The release stop block prevents further movement of the lock lever end 54 of the coupler actuator toward the front pin grabber 36. With the lock lever end held in place, the coupler hook 42 is forced to the released position.

FIG. 2 shows the initial results of an extension of the coupler actuator as the coupler assembly moves toward the engaged position 61, with the piston 51 of the hydraulic cylinder partially extended. With this initial and partial extension of the coupler actuator, the lock bar engage surface 79 on the lock bar is still unable to receive the lock lever arm 78. With the lock lever arm rotational movement halted by the lock bar, being that the lock bar engage surface cannot yet receive the lock lever arm, the lock lever cannot rotate further toward the engage stop block 87, until the coupler hook 42 rotates further about the coupler hook pivot 44.

Further rotation of the coupler hook 42 about the coupler hook pivot 44, allows the lock bar engage surface 79 to receive the lock lever arm 78. As discussed above, the separation distance between the set of pins 25 may be any distance as required for the particular attachment 28 for use with the heavy equipment apparatus. As preferred, the front pin grabber 36 and the rear pin grabber 37 of the coupler assembly 21 is configured to couple with a range of pin diameters, and separation distances, allowing for and compensating for the present wide variation in manufactures' standards. The lock lever 55 rotates off and away from the release stop block 82, toward the engage stop block 87. The coupler hook 42 is locked from retracting to the engaged position 61, which blocks the release of the front pin 26 from the front pin grabber, and so prevents the release of the attachment 28.

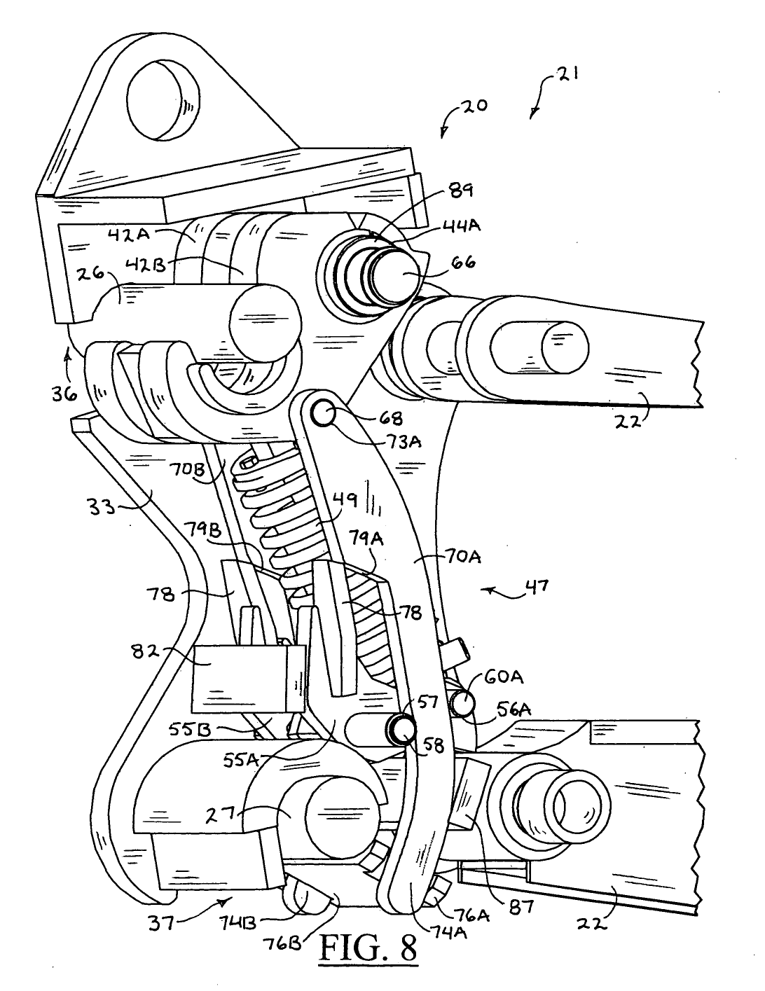

The approximately linear movement of the lock bar 70 as it hinges about the bar pivot 73 on the coupler hook 42, creates the opportunity for the lock lever arm to rotate further and slide into the engaged position 61, in contact with the lock bar along the lock bar engage surface 79, as shown in FIGS. 3 and 8. The lock lever includes a lock lever stop arm 88, approximately opposite to the lock lever arm 78. The lock lever stop arm rotates with the lock lever, against the engage stop block, which bars the lock bar from further movement, thereby preventing the coupler hook of the coupler assembly 21 from releasing the set of pins 25. The coupler actuator 47 is aided by the holding spring 49 acting together in holding the lock lever in this engaged position, until hydraulic pressure is applied to the hydraulic cylinder 48 of the coupler actuator, to retract the piston 51 of the hydraulic cylinder.

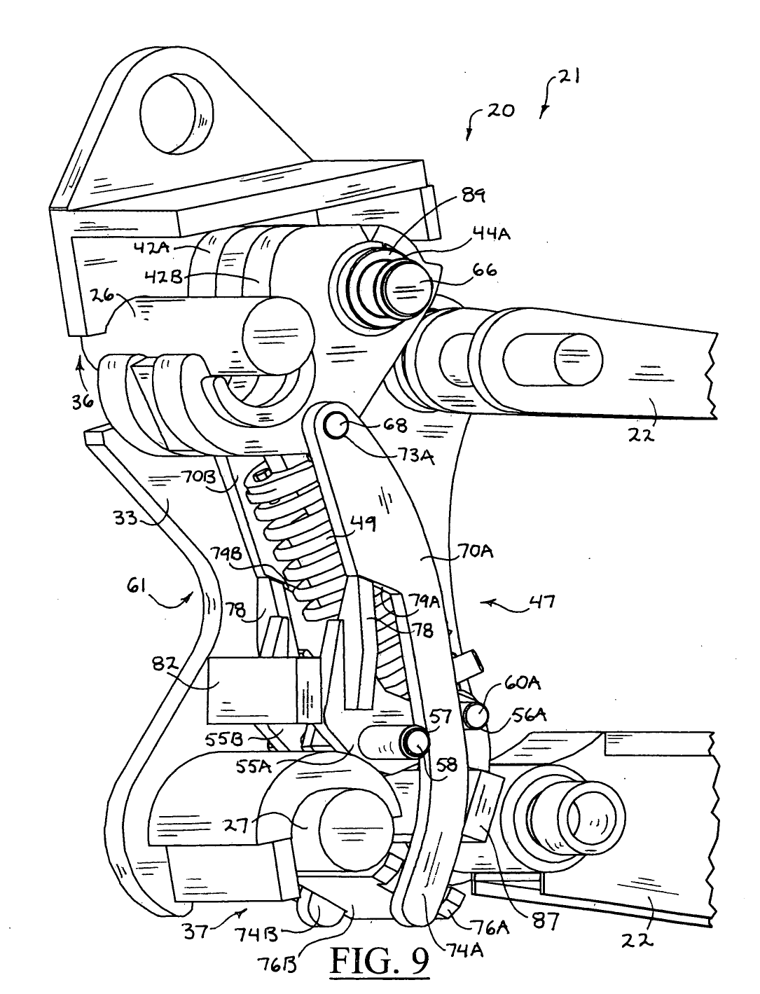

Preferably, the rotation of the lock lever 55 about the lock lever pivot 57 should occur in priority over the rotation of the coupler hook 42 about the coupler hook pivot 44, in the transition to the engaged position 61. As the lock lever rotates, as shown in FIG. 2 transitioning to FIG. 3 and also shown in FIG. 8 transitioning to FIG. 9, the coupler hook is preferably helped to hold its position by a clutch 89, which is a resistive device well known to those skilled in heavy machinery mechanics. The clutch can be employed in the coupler assembly 21, to discourage the rotation of the coupler hook about the coupler hook pivot, at least until the lock lever rotates to contact the engage stop block. The clutch is preferably installed at the coupler hook pivot and is preferably adjustable, to provide the optimum resistance to rotation of the coupler hook about the coupler hook pivot.

From the engaged position 61, as shown in FIGS. 3 and 9, the coupler hook 42 can rotate further, to better and more securely grasp or engage the front pin 26. As shown in FIGS. 4 and 10, the engaged position of the lock lever arm 78 is maintained as the coupler actuator 47 continues to extend and force the coupler hook to rotate about the coupler hook pivot 44, to grasp the front pin more firmly. As the coupler hook rotates further in the engaged position, the lock lever arm separates from the lock bar engage surface, with the lock lever 55 still firmly planted on the engage stop block 87 by the force of the extending coupler actuator equipped with the additional force the holding spring 49.

When the lock lever 55 held in the engaged position 61, the coupler hook 42 cannot rotate about the coupler hook pivot 44. Achieving the release of the front pin 26 must first include the rotation of the lock lever from the engage stop block 87 to the release stop block 82. FIGS. 1 and 6 show the released position 81 of the coupler assembly 21, which in turn accomplishes the release of the front pin. To rotate the lock lever off of the engage stop block 87, the piston 51 of the coupler actuator 47 is partially retracted, causing the lock lever to rotate from the engage stop block to the release stop block. In this rotated position the lock lever arm 78 clears the lock bar engage surface 79 on the lock bar 70, freeing the coupler hook to rotate toward the released position.

Specifically, when the lock lever 55 rests against the release stop block 82, the coupler hook 42 can pivot about the coupler hook pivot 44 by the action of the coupler actuator 47, which retracts the piston 51 into the cylinder body 52. FIG. 1 shows the released position at fill retraction of the coupler actuator, which results in full rotation of the coupler hook and provides for easy removal of the front pin 26 from the front pin grabber 36, followed by the release of the rear pin 27 from the rear pin grabber 37.

Dual-Hook Alternative

Preferably, to best grip and retain the front pin 26, two coupler hooks 42 can be employed in the coupler assembly 21 of the present invention. A first coupler hook 42A and a second coupler hook 42B are utilized in tandem, with the bar pin 68 in common, to rotate about a first coupler hook pivot 44A and a coupler hook pivot 44B. The first and second coupler hooks are most preferably position on each side of or “sandwich” the hook end 53 of the coupler actuator 47.

In this preferred, dual-hook embodiment of the coupler assembly 21, as shown in FIGS. 6 through 9, the lock bar 70 comprises a first lock bar 70A and a second lack bar 70B. Just as with the first coupler hook 42A and the second coupler hook 42B, one of the lock bars is positioned on each side of, or sandwich, the coupler actuator 47. The first and second lock bars preferably rotate about the bar pivot 73 on a common axis, but with separate bar pins 68. Most preferably, each lock bar includes its own bar pivot. Namely, the first lock bar includes a first bar pivot 73A, and the second lock bar includes a second lock bar pivot 73B. The first lock bar pivot hinges about a first bar pin 68A, the second lock bar pivot hinges about a second bar pin 68B, each of which extend from the hook end of 53 of the coupler actuator 47.

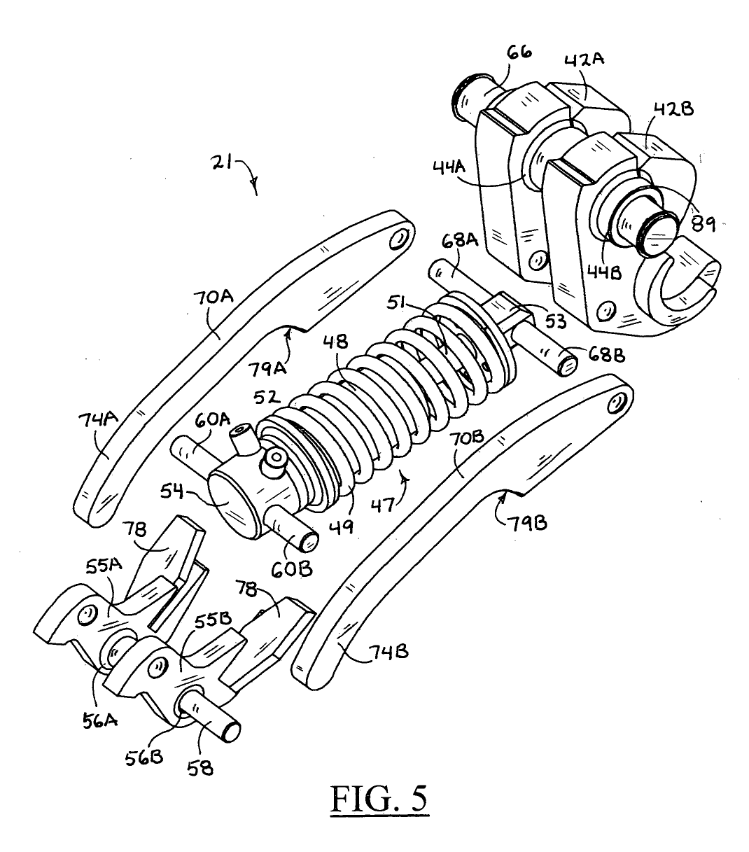

Most preferably, the first bar pivot 73A and a first hook actuator pivot 63A are co-located on the first bar pin 68A. Likewise, the second bar pivot 73B and a second hook actuator pivot 63B are preferably co-located on the second bar pin 68B. Most preferably, the first bar pin and the second bar pin are two ends of the bar pin 68, which penetrates through the hook end 53 of the coupler actuator 47, as shown in FIG. 5. Action of the coupler actuator 47 forces the first coupler hook 42A and the second coupler hook 42B, to rotate together, in tandem, about the hook pin 66. This action of the coupler hooks cranks the first lock bar 70A and the second lock bar 70B, which hinge on the first and second bar pivots, respectively.

The first lock bar 70A includes a first lock bar arm 74A and a first lock bar engage surface 79A. The second lock bar 70B has a second lock bar arm 74B and a second lock bar engage surface 79B. The lock bar collar 76 for guiding each lock bar includes a first lock bar collar 76A, which receives the first lock bar arm, and a second lock bar collar 76B, which receives the second lock bar arm.

Additionally, in this dual-hook embodiment, the lock lever 55 is preferably constructed with a first lock lever 55A and a second lock lever 55B, in tandem, essentially “sandwiching” the coupler actuator 47, as shown in FIGS. 5 through 9. Preferably, the first and second lock levers rotate about the lock lever pivot 57 on the common lever pin 58. Most preferably, each lock lever includes its own lever actuator pivot 56. Namely, the first lock lever includes a first lever actuator pivot 56A, and the second lock lever includes a second lock lever pivot 56B. The first lock lever pivot hinges about a first lever actuator pin 60A, the second lock lever pivot hinges about a second lever actuator pin 60B, each of which extend from the lock lever end of 54 of the coupler actuator 47. Preferably, the first and second actuator pins are two ends of the actuator pin 60, which penetrates through the cylinder body 52 of the coupler actuator 47, as shown in FIG. 5.

Dual Actuator Alternative

In an additional alternative embodiment of the present invention, a single lock bar 70 could be utilized, with a coupler hook 42, coupler actuator 47, and lock lever 55 mounted on each side of the lock bar in tandem, essentially sandwiching the lock bar. However, this alternative configuration of the coupler assembly 21 requires that the lock bar be thick enough, with a lock bar stop surface 79 wide enough to receive the lock lever arm 78 of both tandem mounted lock levers, which pivot about a common lever pivot 57. This alternative is less desirable to the preferred configuration with the dual lock bars, due to the inherent difficultly in synchronizing the action of two hydraulic cylinders 48, to prevent side-to-side action or “walking” of the coupler assembly. Additionally, multiple hydraulic cylinders add costs and complexity to the manufacture and operation of the coupler assembly 21.

Additionally, in the present alternative, other types of actuators than the preferred hydraulic cylinder 48, are considered for use as the coupler actuator 47. As discussed above, the coupler actuator is most preferably a conventional, hydraulically actuated piston 51 and cylinder body 52 combination, as typically employed in heavy equipment. As preferred, the hydraulic cylinder is actuated under the control of the operator of the heavy equipment apparatus 24. Alternatively, the coupler actuator can be operated remotely, or powered by alternative methods, such as pneumatic pressure, conventional gears or transmissions. The hydraulic system of the heavy equipment is typically well suited to add the additional, conventional controls and fluid routing needed for the hydraulic cylinder of the coupler lock system 20. As an alternative to the hydraulic actuator, a manually or a servo cranked ratchet gear, screw or alternatively, a conventional rack and pinion, could be employed. Such a geared actuator alternative would actuate as needed to rotate the coupler hook 42 and the set it at any desired position about the coupler hook pivot 44.

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

1. (canceled)

2. A coupler lock apparatus for use with heavy equipment, the coupler lock apparatus comprising:
a coupler frame, including a pin grabber, the pin grabber for receiving and holding a pin;
a coupler hook rotatable to engage the pin, the coupler hook pivotably attached to the coupler frame at a coupler hook pivot, and the coupler hook rotatable about the coupler hook pivot by action of a coupler actuator;
a lock lever, the lock lever rotatable about a lock lever pivot, the lock lever including a lock lever arm, the lock lever arm positioned opposite a lever actuator pivot in relation to the lock lever pivot;
a lock bar including a bar pivot, an engage surface, and a lock bar arm, the lock bar hingably attached to the coupler hook at the bar pivot; and
the lock lever rotatable to contact the engage surface of the lock lever arm, to stop movement of the lock bar.

3. The coupler lock apparatus of claim 2, wherein:
the lock lever is rotatable to contact the engage surface of the lock lever arm, to prevent further rotation of the coupler hook, and to prevent a release of the pin from the pin grabber

4. The coupler lock apparatus of claim 2, wherein:
an actuation of the coupler actuator pivotably cranks the lock lever about the lock lever pivot.

5. The coupler lock apparatus of claim 2, wherein:
the lock bar, the lock lever, engage together to prevent a release of the pin from the pin grabber.

6. The coupler lock apparatus of claim 2, additionally including:
a lock bar collar, and the lock bar arm extendable through the lock bar collar; and
the lock bar maintained in an approximately linear action, for secure engagement of the engage surface of the lock bar by the lock lever as the coupler hook rotates about the coupler hook pivot, and as the lock bar extends through the lock bar collar.

7. A coupler lock apparatus for use with heavy equipment, the coupler lock apparatus including:
a coupler frame, the coupler frame including a pin grabber, the pin grabber for receiving and holding the pin in an engaged position;
a coupler hook rotatable to engage the pin, the coupler hook pivotably attached to the coupler frame at a coupler hook pivot;
a lock lever, the lock lever rotatable about a lock lever pivot;
a coupler actuator pivotably attached to the coupler hook at a hook actuator pivot, the coupler actuator piviotably attached to the lock lever at a lever actuator pivot, and an actuation of the coupler actuator pivotably cranks the lock lever about the lock lever pivot;
a lock bar including a bar pivot and an lock bar engage surface, the lock bar hingably attached to the coupler hook at the bar pivot, the lock bar rotatable with the coupler hook as the actuation of the coupler actuator cranks the coupler hook about the coupler hook pivot; and
the lock lever arm contactable to the lock bar engage surface, to prevent movement of the coupler hook out of the engaged position to release the pin.

8. The coupler lock apparatus of claim 7, wherein:
the bar pivot is co-located with the hook actuator pivot on the coupler hook.

9. The coupler lock apparatus of claim 7, wherein:
the lock bar includes a lock bar arm opposed to the bar pivot about the. lock lever pivot, the lock bar arm extendable through a lock bar collar.

10. The coupler lock apparatus of claim 9, wherein:
the lock bar extends through the lock bar collar to maintain the lock bar in an approximately linear action, for secure engagement of the engage surface by the lock lever as the coupler hook rotates about the coupler hook pivot.

11. The coupler lock apparatus of claim 7, wherein:
the rotation of the coupler hook about the coupler hook pivot selectively engages or releases the front pin.

12. The coupler lock apparatus of claim 7, wherein:
the coupler actuator includes a hydraulic cylinder within a holding spring, the holding spring coaxially receives the hydraulic cylinder, and the holding spring prevents the coupler actuator from an inadvertent retraction from the engaged position.

13. A coupler lock apparatus for use with heavy equipment, the coupler lock apparatus including:
a coupler frame, the coupler frame including a front pin grabber and a rear pin grabber, the front pin grabber for receiving and holding the front pin in an engaged position, and the rear pin grabber receives and holds a rear pin, of a set of pins;
a coupler hook rotatable to engage the front pin, the coupler hook pivotably attached to the coupler frame at a coupler hook pivot;
a lock lever, the lock lever rotatable about a lock lever pivot;
a coupler actuator pivotably attached to the coupler hook at a hook actuator pivot, the coupler actuator piviotably attached to the lock lever at a lever actuator pivot, and an actuation of the coupler actuator pivotably cranks the lock lever about the lock lever pivot;
a lock bar including a bar pivot, a lock bar arm, and an lock bar engage surface, the lock bar arm opposed to the bar pivot about the lock lever pivot, the lock bar arm extendable through a lock bar collar, the lock bar hingably attached to the coupler hook at the bar pivot, the lock bar rotatable with the coupler hook as the actuation of the coupler actuator cranks the coupler hook about the coupler hook pivot, and the bar pivot co-located with the hook actuator pivot on the coupler hook; and
the lock lever arm contactable to the lock bar engage surface, to prevent movement of the coupler hook out of the engaged position to release the front pin.
